(19) United States
(12) Patent Application Publication
(10) Pub. No.: US 2017/0286391 A1
(43) Pub. Date: Oct. 5, 2017

(54) SYSTEM AND METHOD FOR CREATING VISUAL OR DOCUMENT OUTPUT FOR NON-NARRATIVE DATA ENTERED INTO AN INVENTION DISCLOSURE APPLICATION

(71) Applicants: Eric Jeffords Leininger, New Orleans, LA (US); Mitchell Klein, New Orleans, LA (US); Thomas Stuart, Metairie, LA (US)

(72) Inventors: Eric Jeffords Leininger, New Orleans, LA (US); Mitchell Klein, New Orleans, LA (US); Thomas Stuart, Metairie, LA (US)

(21) Appl. No.: 15/507,230

(22) PCT Filed: Aug. 28, 2015
(86) PCT No.: PCT/US15/47600

§ 371 Date: Feb. 27, 2017

Related U.S. Application Data
(60) Provisional application No. 62/044,039, filed on Aug. 29, 2014.

(51) Int. Cl. G06F 17/24

(52) U.S. Cl. CPC G06F 17/248

(57) ABSTRACT

The present invention comprises a computer implemented invention further comprising a knowledge extraction module for production of an invention disclosure dataset. The present invention further comprises a natural language generation module for converting an invention disclosure dataset into text that may be used in drafting a patent application.

### CROSS-REFERENCE TO RELATED APPLICATIONS

Not applicable

### STATEMENT REGARDING FEDERALLY FUNDED RESEARCH

Not Applicable

### REFERENCE TO A MICROFICHE APPENDIX

Not applicable

### BACKGROUND OF THE INVENTION

### Field of the Invention/Technical Field

The present invention is in the technical field of computer-mediated patent application preparation.

### Description of Related Art/Background Art

PCT/US2014/49510 (“the '510 publication”), which is incorporated herein by reference, discloses that patent applications may be rapidly and accurately disclosed using an automated invention disclosure and patent application drafting software for the production of a disclosure application. The disclosure application allows one to create, rearrange and edit the relationships between the elements, steps and limitations of an invention. The system and method disclosed in the '510 publication rapidly and efficiently characterizes inventions according to the rules and conventions of patent law, preferably U.S. patent law.

In the '510 publication and the invention disclosed herein, certain embodiments employ an art-recognized software architecture for implementing user interfaces known as model-view-controller (MVC) system. In the MVC system, the model structures an area of expertise that must be examined, also known as the problem domain, independent of the user interface. The model directly manages the input data, logic and rules of the application. In the MVC system, the view component generates an output presentation. The view encompasses any representation of information. However, examples include charts and diagrams. Importantly, multiple views of the same information are possible. The third part, the controller, accepts input and converts it to commands for the model or view. For example, the controller may send commands to the model to update the model state (e.g., editing a document). It can also send commands to its associated view to change the view's presentation of the model (e.g., by scrolling through a document).

Text entered into a system related to the present invention is thought to be directly linked to the output of a document, preferably a patent application document. For example, in a disclosure application, which contains disclosure views, (which are interface components representing elements or steps of an invention), the arrangement of the views themselves, create text for the detailed description portion of the patent application. Further, limitations can be added to each element, which are capable creating text for documents such as patent applications. It was discovered through use of the disclosure application, that the arrangement of the disclosure views and limitation views, can be useful for organizing data used in drafting patent related text documents.

### GENERAL SUMMARY OF THE INVENTION

Embodiments of the present invention relate to a method of comparing tangentially related data to an invention.

Embodiments of the present invention allow for evaluation of prior art. Finally, embodiments of the present invention allow evaluation and demarcation of prior art and novel elements.

Embodiments of the present invention allow for evaluation of novelty.

Embodiments of the present invention compare an amendment to something that was initially filed before filing.

### BRIEF DESCRIPTION OF THE DRAWINGS

FIG. 1 diagrams network communication of an embodiment of the invention.

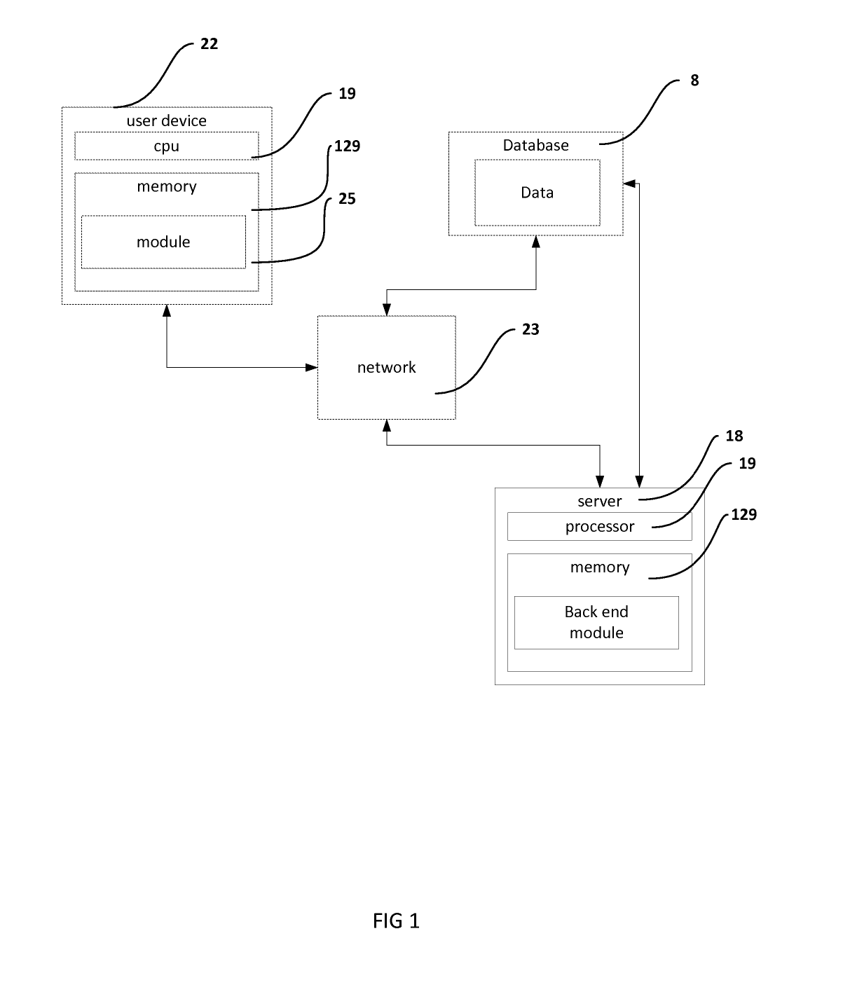

FIG. 2 diagrams the relationships between modules and user devices.

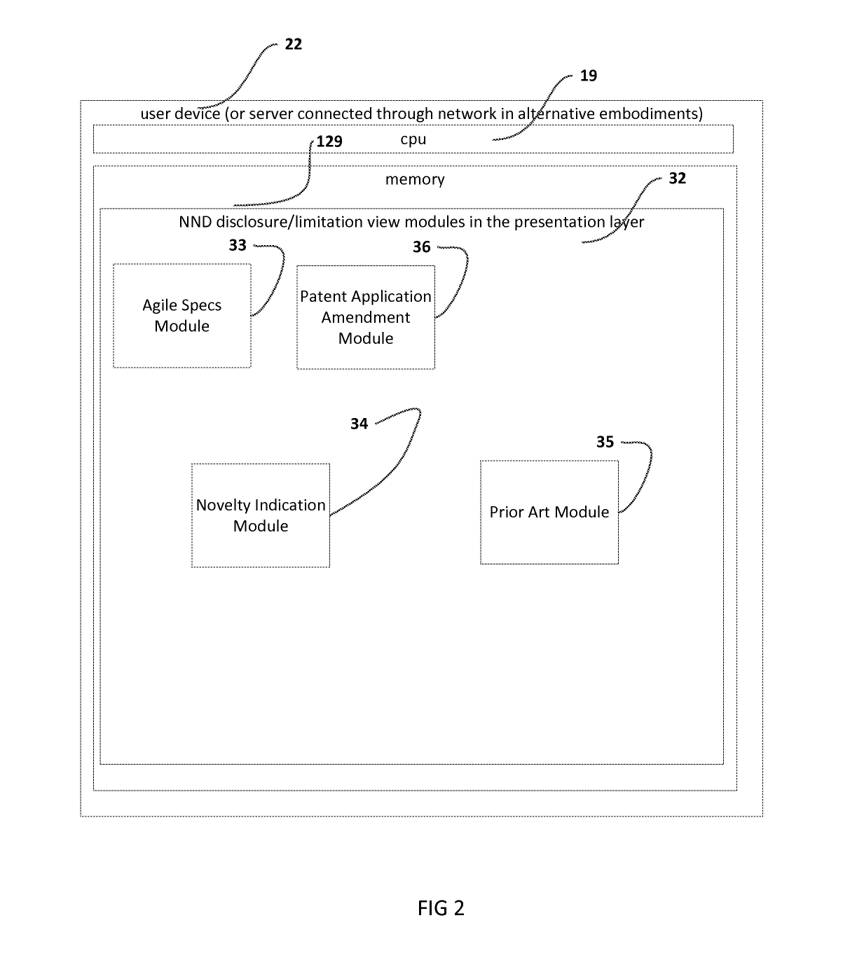

FIG. 3 diagrams steps showing the overall use of the invention.

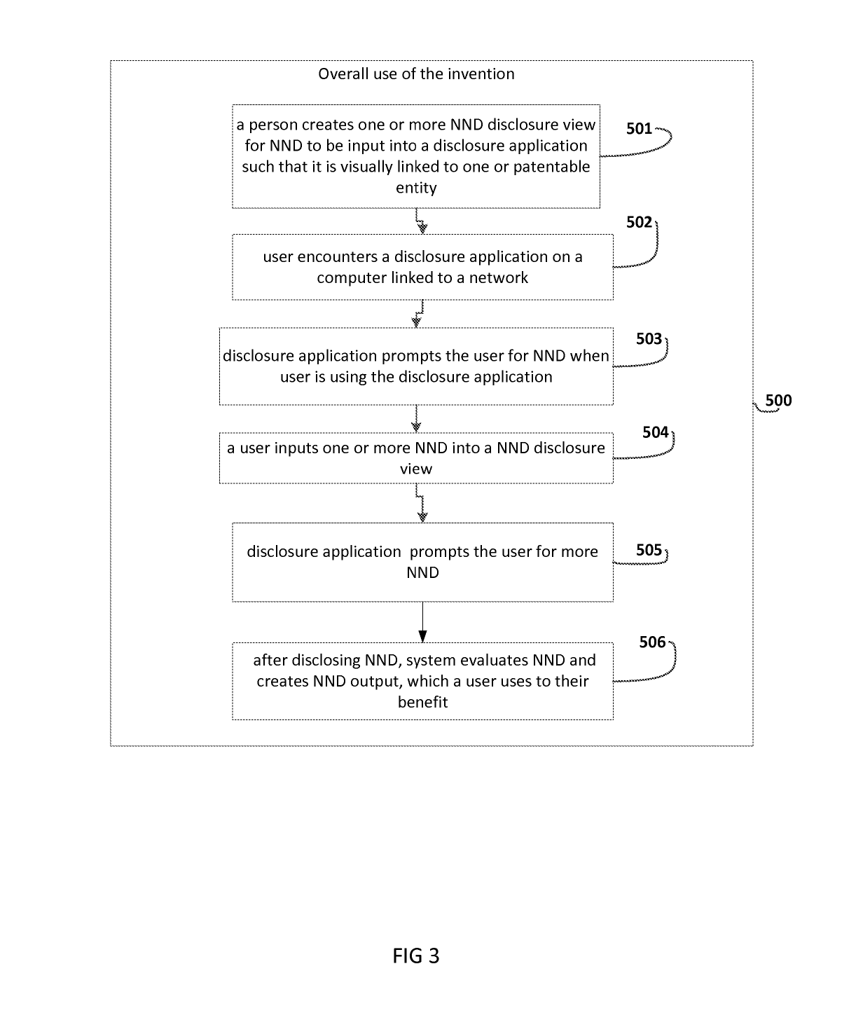

FIG. 4 illustrates a disclosure view wherein an element is associated to prior art by the nesting of the type of prior art underneath said disclosure view.

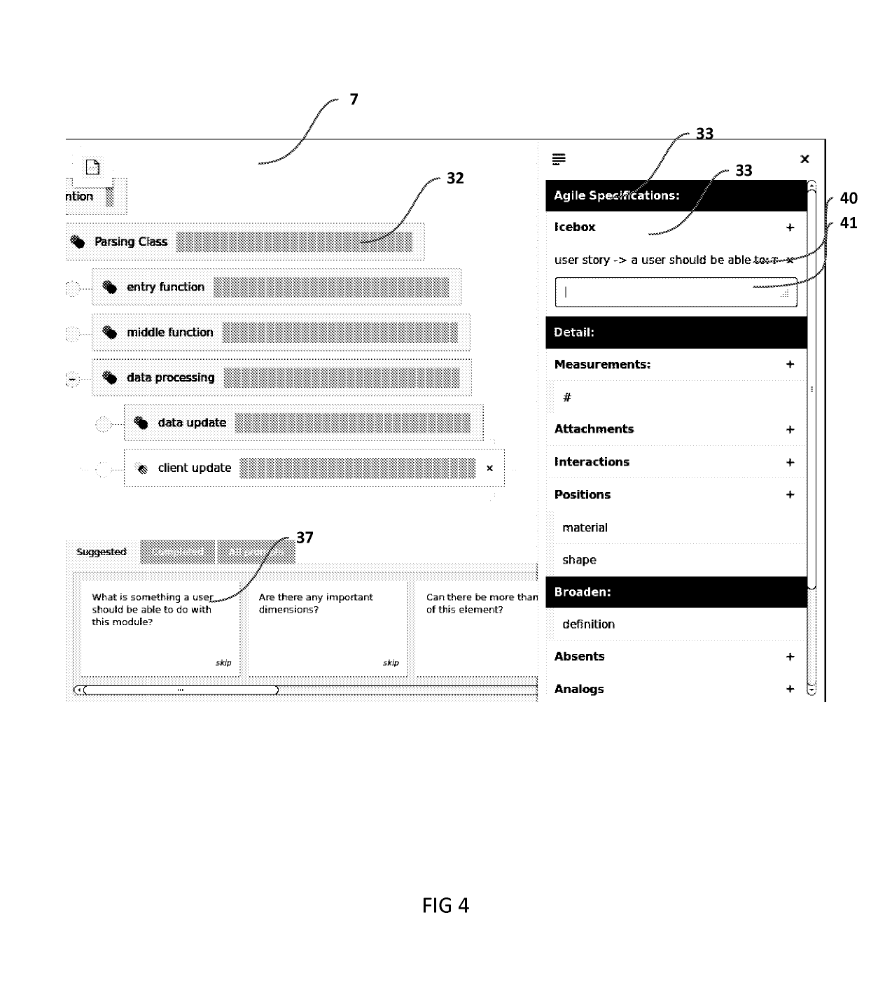

FIG. 5 illustrates an interface view wherein a limitation view and prompt associated with enabling the user to associate agile specification information with a patent element.

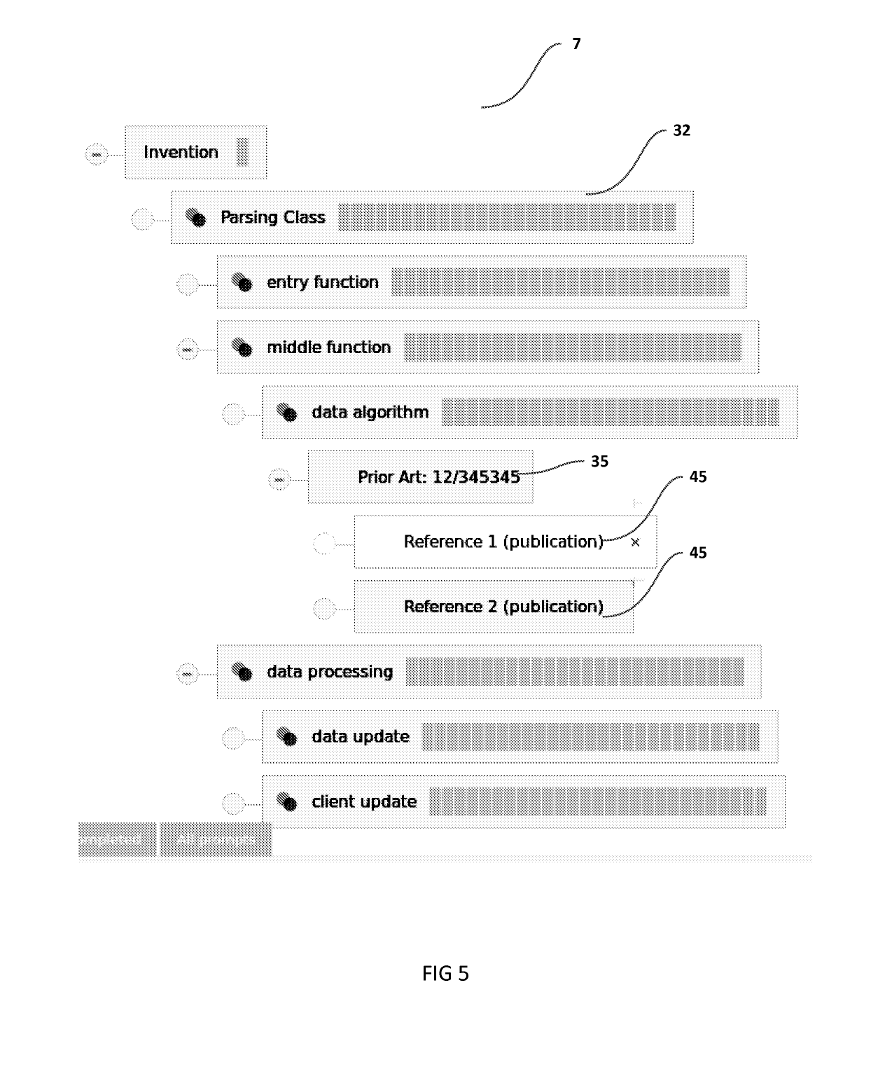

FIG. 6 illustrates an interface view that shows a limitation view showing the differences in input based on the original data and the amendment data.

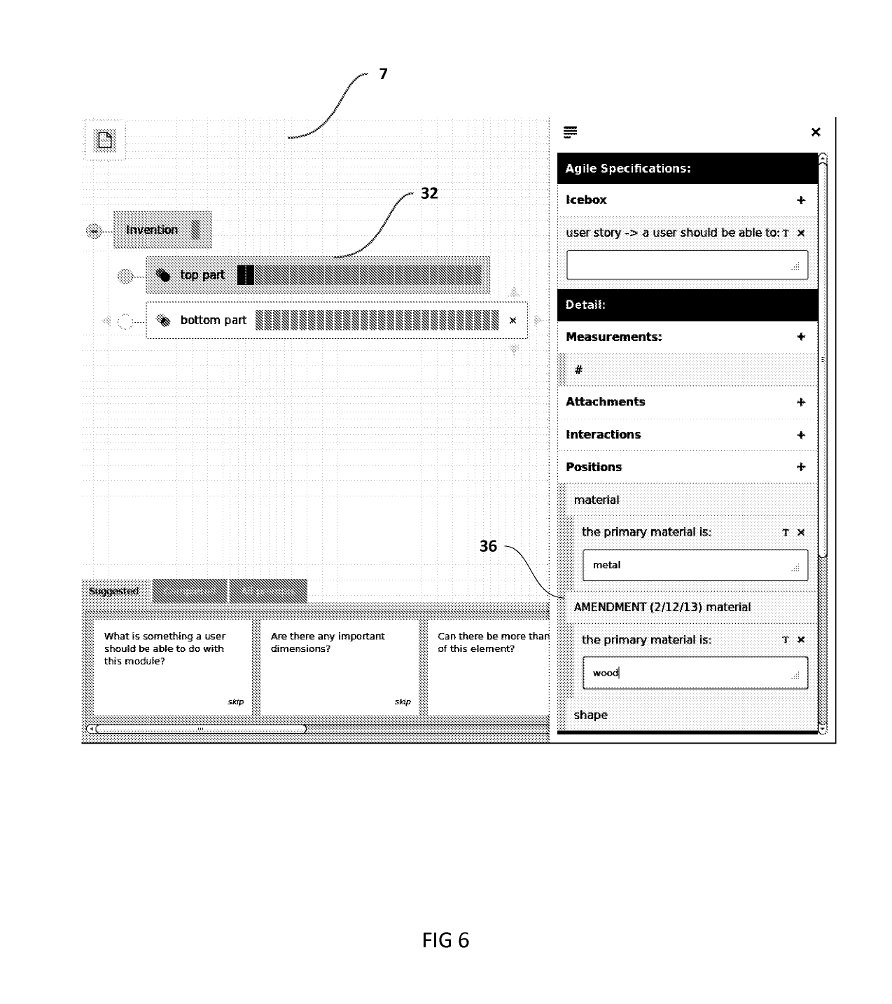

FIG. 7 illustrates an interface view that highlighting presumptive novelty to user through a plurality of multiple disclosure.

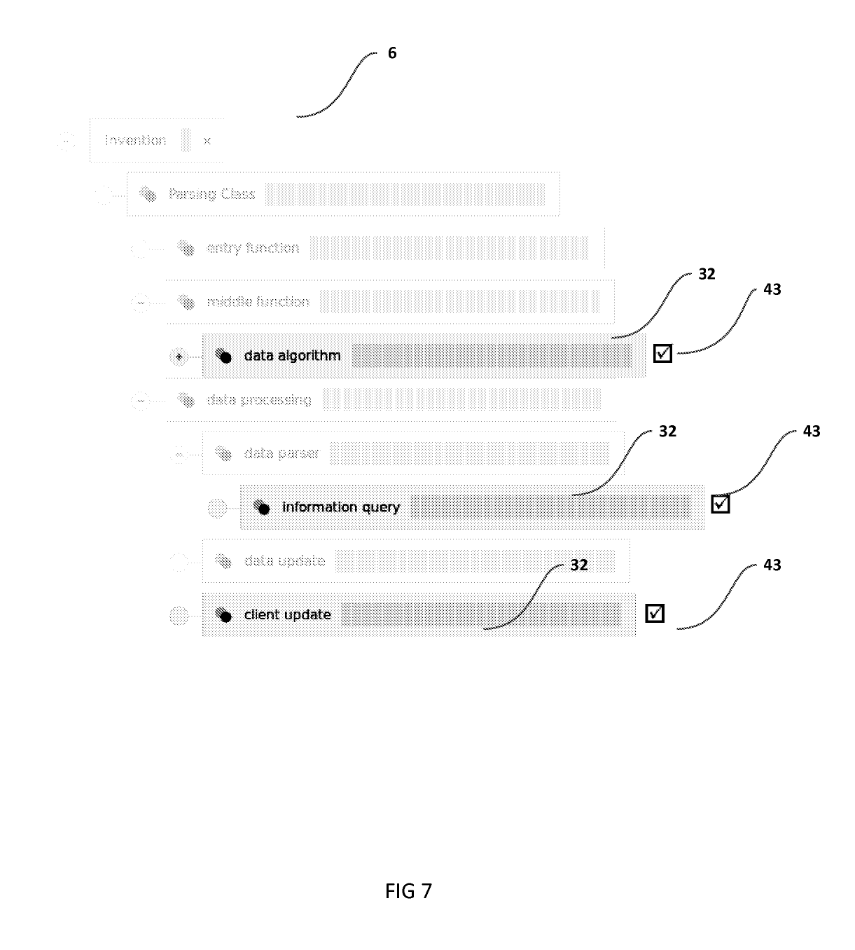

### DETAILED DESCRIPTION OF THE INVENTION

In general it is thought that this invention is a novel means for creating novel document or visual output from associating inputs with patentable entities in a disclosure application. The invention is performed on a user device and/or server and the user device may be any type of general computing device, such as a mobile computing device, laptop, netbook, server, cell phone, smart phone, personal digital assistant, tablet computer, or any other device capable of executing one or more instructions. The user device and server may contain one or more processors, such as processors which may be a central processing unit (CPU), a microprocessor, a general purpose processor, an application specific processor, or any device that executes instructions. The user device and server may also include one or more memories, that store data one or more software modules. The memory may be implemented using any computer-readable storage medium, such as hard drives, CDs, DVDs, flash memory, RAM, ROM, etc. The memory may store a module, or application, or interface, library or engine which may be executed by processor. The user interface may include one or more of a screen, a display, a projector, a touch panel, a pointing device, a scrolling device, a button, a switch, a motion sensor, an audio sensor, a pressure sensor, a thermal sensor, etc. which may interact with a presentation layer of a module. The presentation layer may include, modules that allow the user to create non narrative data output from use with the disclosure application. Some embodiments of a presentation layer may be a web browser 273, a stand-alone application 274, and a virtual reality headset, augmented reality glasses or overlays, or a messaging interface 275.

The user interface may be web based, such as a web page, or a stand-alone application. The user interface may also be configured to accept information about a user, such as user feedback. The user may manually enter the information, or it may be entered automatically. The system may also include one or more data bases, such as database on a device or server. Database may be implemented using any database technology known to one of ordinary skill in the art, such as relational database technology or object-oriented database technology such as MongoDb or Nosql databases.

Overall, the invention requires an existing disclosure application wherein said disclosure application has nested elements, or steps called disclosure views containing or referencing a patentable entity. These elements or steps describe the components of the invention in a nested functional or relational manner and this invention is one or modules designed to relate to the elements in order to produce data that is not specifically related to the preparation of a patent application.

The invention has several sub steps for using it which are as follows: a person creates one or more NND disclosure view 32 for NND 26 to be input into a disclosure application 7 such that it is visually linked to one or patentable entity 29 (herein termed the Method (1)-Step (1) 501. Next, user encounters a disclosure application 7 on a computer 31 linked to a network 23, (herein termed the Method (1)-Step (2) 502). Then, a disclosure application 7 prompts the user for NND 26 when user is using the disclosure application 7, (herein termed the Method (1)-Step (3) 503). Then, a user inputs one or more NND 26 into a NND disclosure view 32, (herein termed the Method (1)-Step (4) 504). Next, the disclosure application 7 prompts the user for more NND 26, (herein termed the Method (1)-Step (5) 505). Finally, after disclosing NND 26, system evaluates NND 26 and creates NND output 49, which a user uses to their benefit, (herein termed the Method (1)-Step (6) 506). The aforementioned

While the steps in Method (1) 500 are depicted in a particular order, the principles of the present disclosure are not limited to the order depicted immediately above. Additionally, embodiments of the Method (1) 500 process can include more or less steps than those depicted.

It is thought this method requires the creation of one or more NND disclosure view 32 and there are many objectives, which the NND disclosure view 32 intends to perform. To begin, the NND disclosure view 32 aims to have a way to put in data that is tangentially related to a patent application, but not directly related to the narrative output. Further, the NND disclosure view 32 functions to have a way to update and change NND 26 easily and relate to specific patentable entity 29 as a piece of nested data. Further, the NND disclosure view 32 aims to have a way to easily visualize patent-related data within the context of the patent application. Additionally, the NND disclosure view 32 intends to have a way to make a patent entity multi-dimensional.

Examples of different types of NND disclosure view 32 are thought be an agile limitation view 33, a novelty interface 34, a prior art element disclosure view 35, and an amendment limitation view 36. For example, the agile limitation view 33 may comprise 5 items; the icebox prompt 37, the story input 38, the story fragment 39, the icebox fragment 40, and the icebox input 41. The agile limitation view 33 is intended to both 1) have a means to create software specs and intellectual property simultaneously and also to 2) create a way to associate specific software, functions or modules to an icebox or user story.

The icebox prompt 37 of the agile limitation view 33 has several aims, which are as follows: First, the icebox prompt 37 intends to remind the user along with the patent related information, to create or assign a story to an icebox. Further, the icebox prompt 37 aims to remind the user along with the patent related information, to create a user story related to the patentable entity. Further, the icebox prompt 37 is designed to give the user an option to define one or more stories related to the entity.

Another component of the agile limitation view 33 is the story input 38. The story input 38 is designed to have a means that someone can input software specs. Further, the story input 38 is designed to have a means that someone can choose the person who benefits from the user feature. Further, the story input 38 aims to have a means to relate a patentable entity 29 to a user story.

Similar to the story input 38 is the icebox input. The term icebox input 41 is thought to encompass one or more fields that allows the user to create an icebox entity, which holds one or more stories, which text is then used by developers to create software. The objectives of the icebox input 41 are to both 1) have a means where someone can create broad goals for software development and 2) have a means where someone can assign user stories under these broad goals.

Another example of a NND disclosure view is the novelty interface. In one embodiment this may be a single element, the Boolean novelty checkmark 43 which functions to have an easy mechanism to point out how existing art is separated from the novel combinations of elements in the patent application. The term novelty interface 34 is broadly thought to include one or more portions of an interface that mark a level within a nested tree of patentable entity 29 that allows one to demarcate the presumed level where prior art does not exist. The novelty interface 34 has many aims, which are as follows: First, the novelty interface 34 is designed to have a simple means to start drafting claims. Also, the novelty interface 34 is designed to show or hide different elements based on novelty. Further, the novelty interface 34 aims to examine patent examiners responses to presumed levels of novelty. Additionally, the novelty interface 34 aims to easily change (narrow/broaden) the scope of the invention by making disclosure view 5 as novel or non-novel.

In one embodiment, the NND disclosure view may be a prior art element disclosure view 35 which may comprise a patent application information view 44, a publication information view 45, and/or a product information view 46. The term prior art element disclosure view 35 is thought to encompass one or more portions of an interface that are marked as prior art and are related to a patentable entity 29 in a disclosure view 5 by being prior art of said entity. One purpose of the prior art element disclosure view 35 is to have an easy way for a user to create a rebuttal to examiner by determining if the cited prior art is relevant to the application as filed.

The patent application information view 44 is to have an easy way for a user to associate a prior art patent with a particular entity. The publication information view 45 is intended to have an easy way for a user to associate a prior art publication with a particular entity. The publication information view 45 preferably consists of two items, the publication information fragment 47 and the publication information input 48. The product information view 46 is intended to have an easy way for a user to associate a prior art product with a particular entity.

The term patent application information view 44 is thought to encompass an interface on a presentation layer 24 that allows one to associate a disclosure view 5 or patentable entity 29 with a reference to a patent application that has prior art related to the patentable entity 29. The term publication information view 45 is broadly thought to include an interface on a presentation layer 24 that allows one to associate a disclosure view 5 or patentable entity 29 with a reference to a publication that has prior art related to the patentable entity 29. The term publication information input 48 is preferred, the term product information view 46 may include an interface on a presentation layer 24 that allows one to associate a disclosure view 5 or patentable entity 29 with a reference to a product that has prior art related to the patentable entity 29.

In another embodiment, the NND disclosure view could be an amendment limitation view 36 which would function to both 1) have a way to rebut an examiner who claims that there is new matter in the application and also to 2) compare an amendment to the filed application to see if there is new matter before filing.

Usage of these views may result in some form of NND output. Including agile specs 50, (software specs created from a disclosure application 7), invention differences 51 (prior art differences between the claimed invention and highlight potential means for rebuttal to the examiner), a novelty map 52 (a means to quickly examine areas of novelty of invention and devise one or more claims strategy) and/or amendment differences 53 (a means to evaluate differences between an application and its amendments for potential new matter).

The invention comprises numerous terms that are necessary to define the scope of for purposes of interpretation. The invention consists of many accompanying pieces; the module 25, the presentation layer 24, the element association 3, the inventor 4, the disclosure view 5, the limitation view 6, the disclosure application 7, the database 8, the client server model 9, the program 10, the CPU 19, the software 12, the view 13, the crud object 14, the user interface 21, the user device 22, the network 23, the server 18, the CPU 19, the user input 20, the user interface 21, the user device 22, the network 23, the presentation layer 24, the module 25, the NND 26, the non-narrative data 27, the definition of these terms below allows numerous embodiments of the invention that may arise, rather than just the preferred embodiment as described above.

The term NND disclosure view 32 is thought to encompass a presentation layer 24 input that allows the user to create a relationship between NND 26 and a patentable entity 29 that is draggable and a crud object 14. The term agile limitation view 33 is thought to encompass an interactive view in the presentation layer 24 created from one or more module 25 that allows one to mix patentable entity 29 and agile specs 50, such that the output allows one to begin the process of agile workflow.

The term icebox prompt 37 is broadly thought to include a text portion of a view in the presentation layer 24 that prompts the user to input agile icebox or story information. The term icebox input 41 is thought to encompass one or more fields that allows the user to create an icebox entity, which holds one or more stories, which text is then used by developers to create software. The term novelty interface 34 is broadly thought to include one or more portions of an interface that mark a level within a nested tree of patentable entity 29 that allows one to demarcate the presumed level where prior art does not exist.

The term Boolean novelty checkmark 43 is thought to encompass a check interface on a presentation layer 24 most likely a disclosure view 5 that creates an arbitrary level where the user indicates that prior art is not present. The term prior art element disclosure view 35 is thought to encompass one or more portions of an interface that are marked as prior art and are related to a patentable entity 29 in a disclosure view 5 by being prior art of said entity. The term patent application information view 44 is thought to encompass an interface on a presentation layer 24 that allows one to associate a disclosure view 5 or patentable entity 29 with a reference to a patent application that has prior art related to the patentable entity 29.

The term publication information view 45 is broadly thought to include an interface on a presentation layer 24 that allows one to associate a disclosure view 5 or patentable entity 29 with a reference to a publication that has prior art related to the patentable entity 29. The term publication information input 48 is thought to encompass one or more fields that allows the user to create evaluate or compare different iterations of an invention that have been modified over time. In some embodiments, not just the preferred, the term product information view 46 may include an interface on a presentation layer 24 that allows one to associate a disclosure view 5 or patentable entity 29 with a reference to a product that has prior art related to the patentable entity 29.

The term amendment limitation view 36 is thought to encompass one or more portions of the presentation layer 24 that allow one to compare initially filed applications, with amended applications to show the differences in extant elements versus amended elements to evaluate issues of new matter. The term NND output 49 is broadly thought to include any output from a disclosure application 7 that uses association of NND 26 with one or more disclosure view 5 to create a document or visual output that is useful to a user. The term agile specs 50 is thought to encompass an API or document output that populates data in an Agile Management Software package.

The term invention differences 51 is broadly thought to include an document or visual output of the differences or data related to prior art elements present in a disclosure application 7. In some embodiments, not just the preferred, the term novelty map 52 may include an document or visual output that shows presumed branches and levels of novelty from data input into a disclosure application 7. The term amendment differences 53 is broadly thought to include an document or visual output that shows differences in disclosure view 5 between an initial filing and an follow up amendment.

In some embodiments, not just the preferred, the term module 25 may include instructions hosted on memory 129 executed by the CPU 19 which perform functions. The term presentation layer 24 is thought to encompass graphical output from a module 25 for user interaction typically one or more graphical user interface 131. The term element association 3 is broadly thought to include the nested relationship between one or more disclosure view 5 (of possibly different types, such as method having steps or step having sub step or step having element) which may determine different type of sentences generated.

The term inventor 4 is broadly thought to include any person, or persons in United States patent law, who contribute to the claims of a patentable invention. The term disclosure view 5 is thought to encompass a part of a disclosure application 7 that is an interactive view 13 within a graphical user interface 131 that is draggable and a crud object 14. The term disclosure application 7 is thought to encompass software 12 or module 25 in a presentation layer 24 on a user device 22 that allows rapid, input of invention information 30 and outputs patent application text.

The term database 8 is thought to encompass an organized collection of data with a software system designed to allow the definition, creation, querying, update, and administration of databases. The term client server model 9 is broadly thought to include structure in computing that partitions tasks or workloads between the providers of a resource or service, called servers, and service requesters, called clients. In some embodiments, not just the preferred, the term program 10 may include a sequence of instructions, written to perform a specified task with a computer that is executed by the central processing unit 128.

The term CPU 19 is broadly thought to include hardware within a computer that carries out the instructions of a computer program by performing the basic arithmetical, logical, and input/output operations of the system. In some embodiments, not just the preferred, the term software 12 may include a collection of computer programs and related data. In some embodiments, not just the preferred, the term crud object 14 may include an acronym for create, read, update and delete graphical user interface 131 objects which are the four basic functions of persistent storage. Also pertains to graphical user interface 131 conventions that facilitate viewing, searching, and changing information for computer 31 forms and reports.

The term server 18 is broadly thought to include a system (software and suitable computer hardware) that responds to requests across a computer network and has a central processing unit (CPU) 19 capable of executing one or more instructions on one or module 25 present on memory 129. In some embodiments, not just the preferred, the term CPU 19 may include hardware within a computer that carries out the instructions of a computer program by performing the basic arithmetical, logical, and input/output operations of the system. The term user input 20 is thought to encompass text or information that is input by the user into one or more module 25 presentation layer 24.

The term user interface 21 is broadly thought to include a display mechanism for a graphical user interface 131 which in turn is part of the presentation layer 24 of one or more module 25. The term user device 22 is broadly thought to include an interactive device that has a CPU 19 and memory 129 with one or more module 25 containing executable instructions, typically a computer 31.

In some embodiments, not just the preferred, the term network 23 may include a telecommunications network that allows computers to exchange data.

In some embodiments, not just the preferred, the term presentation layer 24 may include graphical output from a module 25 for user interaction typically one or more graphical user interface 131. In some embodiments, not just the preferred, the term module 25 may include instructions hosted on memory 129 executed by the CPU 19 which perform functions. The term NND 26 is broadly thought to include an acronym for non-narrative data 27.

The term non narrative data 27 is thought to encompass data that is tangentially related to one or more patentable entity 29 which is input in a presentation layer 24 in a manner that relates the information to one or more disclosure view 5 in a disclosure application 7. The term narrative data 28 is thought to encompass data that is specifically related to the output text of a patent application, created by a disclosure application 7, in that one or more text inputs by the user is word for word input into the text, or alternatively processed by an algorithm which translates the meaning of the text input into a narrative format for the patent application and is applied to the detailed description or other required parts of a patent application. The term patentable entity 29 is thought to encompass fundamental pieces of an invention such as element, step, means for element, species.

The term invention information 30 is thought to encompass data related to the function, composition, creation, use, or description of an invention including any claimable limitation. In some embodiments, not just the preferred, the term memory 129 may include the physical devices used to store programs (sequences of instructions) or data (e.g. program state information) on a temporary or permanent basis for use in a computer or other digital electronic device. The term operating system 130 is broadly thought to include a collection of software that manages computer hardware resources and provides common services for computer programs.

The term graphical user interface 131 is broadly thought to include a type of user interface that allows users to interact with electronic devices through graphical icons and visual indicators such as secondary notation, as opposed to text-based interfaces, typed command labels or text navigation.

In some embodiments, one may reason that the presentation layer 24 may be also be a web browser 119, a application 120, or a messaging interface 121. When using the invention, one can contemplate that in some embodiments either a web browser 119, a application 120, or a messaging interface 121 may take the place of the presentation layer 24.

When using the invention, one may reason that in some embodiments either a desktop computers 132, a carputers 133, a game consoles 134, a laptops 135, a notebooks 136, a palmtop 137, a tablet 138, a smartphones 139, or a smartbooks 140 may take the place of the computer 31. The computer 31 consists of 4 sub-elements, respectively referred to as the central processing unit 128, the memory 129, the operating system 130, and the graphical user interface 131.

We claim:

1. A method for associating non-narrative, invention-related data within a disclosure application comprising:
a. instantiating a disclosure application having one or more nested hierarchies of elements or steps;
b. entering non-narrative data into a presentation layer of the disclosure application; and,
c. producing visual output after processing of non-narrative data by said disclosure application

2. A system for associating non-narrative invention-related data with a disclosure application comprising:
a. a computer with memory,
b. non-narrative data processing modules with said computer memory wherein non-narrative data is entered into a disclosure application via the CPU and outputs visual information unrelated to the narrative of a patent application.
